(19) United States
(12) Patent Application Publication
(10) Pub. No.: US 2024/0131621 A1
(43) Pub. Date: Apr. 25, 2024

(54) LASER MACHINING DEVICE AND NOZZLE UNIT FOR LASER MACHINING DEVICE

(71) Applicant: KOMATSU INDUSTRIES CORPORATION, Kanazawa-shi, Ishikawa (JP)

(72) Inventors: Yoshihiro YAMAGUCHI, Ishikawa (JP); Nobuhiro TAKATA; Keita KONDOU, Ishikawa (JP)

(21) Appl. No.: 18/548,392

(22) PCT Filed: Apr. 24, 2022
(86) PCT No.: PCT/JP2022/018754

§ 371 Date: Aug. 29, 2023

(30) Foreign Application Priority Data
May 27, 2021 (JP) 2021-089710

(51) Int. Cl. B23K 26/04; B23K 26/08; B23K 26/14; B23K 26/18

(52) U.S. Cl. CPC B23K 26/048; B23K 26/0869; B23K 26/1476; B23K 26/18

(57) ABSTRACT

A laser machining device uses laser light to machine a workpiece disposed in a light-blocking liquid having light-blocking properties. A nozzle unit for the laser machining device includes an inner nozzle through which the laser light passes, a gas outlet port that blows a gas toward the workpiece in order to remove the light-blocking liquid from between the inner nozzle and the workpiece, and a swirler that causes the gas to swirl.

### CROSS-REFERENCE TO RELATED APPLICATIONS

This application is a U.S. National stage application of International Application No. PCT/JP2022/018754, filed on Apr. 25, 2022. This U.S. National stage application claims priority under 35 U.S.C. § 119(a) to Japanese Patent Application No. 2021-089710, filed in Japan on May 28, 2021, the entire contents of which are hereby incorporated herein by reference.

### BACKGROUND

### Field of the Invention

The present invention relates to a laser machining device and a nozzle unit for a laser machining device.

### Background Information

A laser machining device performs machining such as cutting on a workpiece by irradiating the workpiece with laser light from a nozzle. A major portion of the laser light irradiated onto the workpiece is absorbed by the workpiece and melts the workpiece. However, a portion of the laser light is reflected by the workpiece and is scattered thereabout. As a result, a cover, for example, for suppressing the scattering of the laser light is provided to the laser machining device in Japanese Patent Publication No. 5940582. The cover covers the movement range of the nozzle.

### SUMMARY

The cover in the above laser machining device covers the movement range of the nozzle. As a result, the size of the laser machining device is large. In addition, the laser light penetrates the workpiece and is reflected below the workpiece, whereby the laser light may leak outside. When a cover is provided below the workpiece to prevent such leakage of the laser light, the structure of the laser machining device becomes complicated.

Accordingly, the inventor of the present invention has proposed a laser machining device in which the workpiece is disposed in a liquid (referred to below as “light-blocking liquid”) having light blocking properties. The light-blocking liquid is an aqueous solution that includes, for example, an addition agent such as carbon that absorbs light. The workpiece is disposed slightly below the liquid level of the light-blocking liquid. As a result, the surface of the workpiece is covered by the light-blocking liquid.

The laser machining device blows a gas from the nozzle toward the workpiece during machining. Consequently, the laser machining device removes the light-blocking liquid from the surface of the workpiece and machines the workpiece with the laser light. At this time, portions of the surface of the workpiece other than the range (referred to below as “machining range”) where the gas is blown away are covered by the light-blocking liquid. As a result, the leakage of laser light is prevented with a simple structure.

On the other hand, when the light-blocking liquid intrudes into the machining range of the workpiece, the machining quality of the workpiece is reduced in the above laser machining device. Therefore, it is desired that the intrusion of the light-blocking liquid into the machining range of the workpiece is effectively suppressed. An object of the present invention is to effectively suppress the intrusion of the light-blocking liquid into the machining range of the workpiece in a laser machining device.

A nozzle unit according to a first aspect of the present invention is for a laser machining device that uses laser light to machine a workpiece disposed in a light-blocking liquid having light-blocking properties. The nozzle unit includes an inner nozzle, a gas outlet port, and a swirler. The inner nozzle allows the laser light to passes therethrough. The gas outlet port blows a gas toward the workpiece for removing the light-blocking liquid from between the inner nozzle and the workpiece. The swirler causes the gas to swirl.

In the nozzle unit according to the present aspect, a swirling flow of the gas is generated by the swirler and the swirling flow is blown onto the surface of the workpiece. The swirling flow diffuses in a tangential direction at the instant that the swirling flow comes out of the nozzle. As a result, intrusion of the light-blocking liquid into the machining range of the workpiece is effectively suppressed. Consequently, the machining quality of the workpiece is improved.

The laser machining device according to another aspect of the present invention includes a liquid storage tank, a placement stand, a laser generator, a laser head, a drive device, and the abovementioned nozzle unit. The liquid storage tank stores the light-blocking liquid. The placement stand is disposed inside the liquid storage tank. The workpiece is placed on the placement stand. The laser generator generates laser light. The laser head is connected to the laser generator and is disposed above the placement stand. The drive device moves the laser head. The nozzle unit is attached to the laser head. In the laser machining device according to the present aspect, leakage of the laser light is prevented by the light-blocking liquid. In addition, intrusion of the light-blocking liquid into the machining range of the workpiece is effectively suppressed by the nozzle unit. Consequently, the machining quality of the workpiece is improved.

According to the present invention, intrusion of light-blocking liquid into the machining range of the workpiece is effectively suppressed in the laser machining device. Consequently, the machining quality of the workpiece is improved.

### BRIEF DESCRIPTION OF DRAWINGS

FIG. 1 is a perspective view of a laser machining device according to an embodiment.

FIG. 2 is a schematic view of a configuration of the laser machining device.

FIG. 3 is a schematic view of a configuration of the laser machining device.

FIG. 4 is an enlarged view of a laser head and a nozzle unit.

FIG. 5 is a cross-sectional view of the laser head and the nozzle unit.

FIG. 6 is a cross-sectional view of the nozzle unit.

FIG. 7 is an exploded perspective view of the nozzle unit.

FIG. 8 is a cross-sectional view of a swirler.

FIG. 9 is a schematic view of the flow of a gas in a nozzle unit according to a comparative example.

FIG. 10 is a schematic view of the flow of a gas in a nozzle unit according to the present embodiment.

FIG. 11 is a cross-sectional view of the laser head during cutting of the workpiece.

### DETAILED DESCRIPTION OF EMBODIMENT(S)

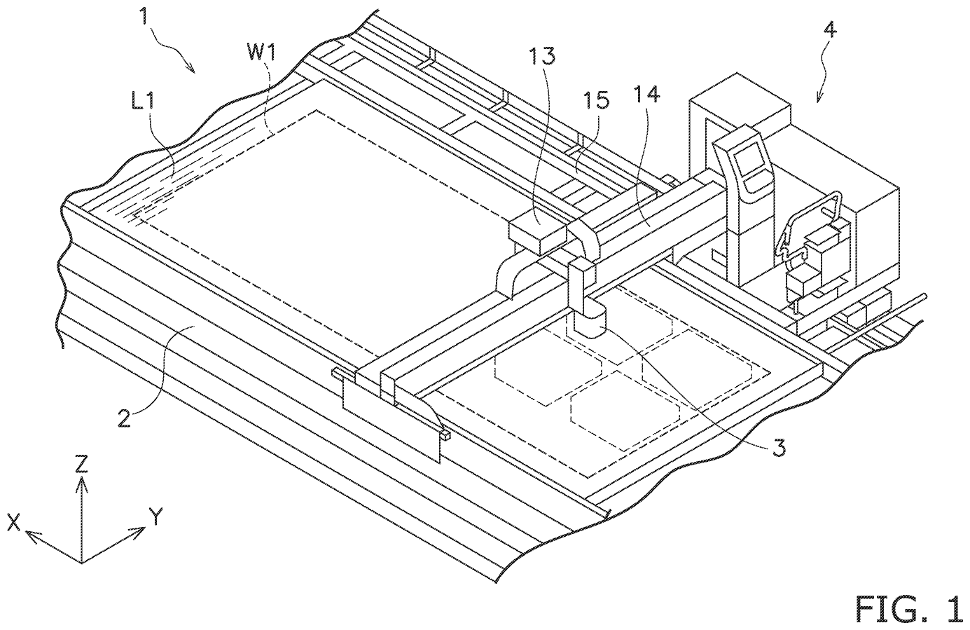

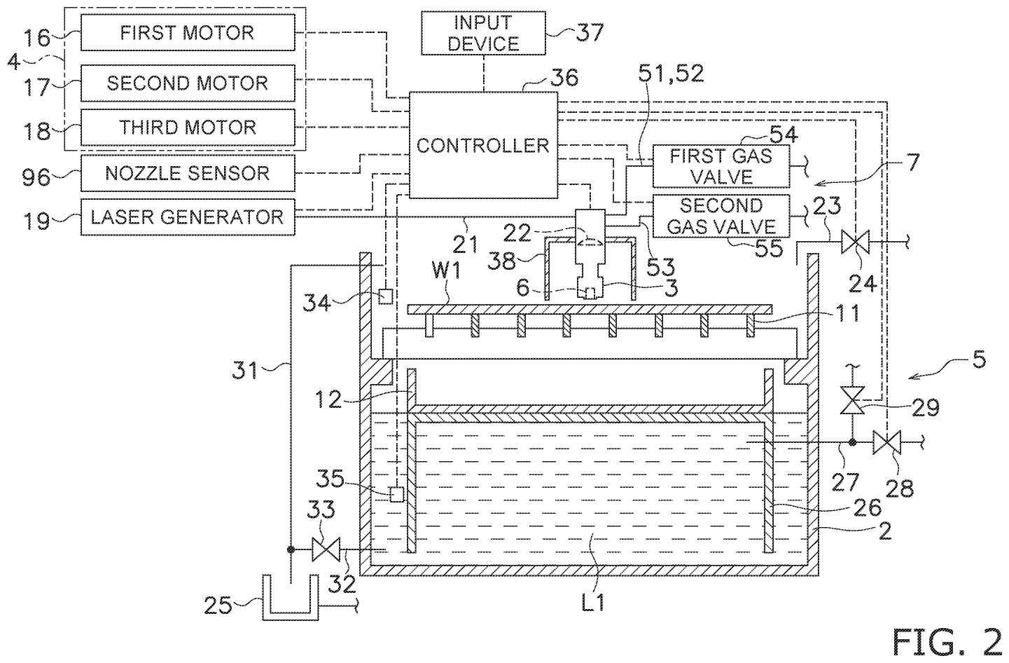

A laser machining device according to an embodiment will be discussed below with reference to the drawings. FIG. 1 is a perspective view of a laser machining device 1 according to an embodiment. FIG. 2 is a schematic view of a configuration of the laser machining device 1. The laser machining device 1 is a device for machining a workpiece W1 with laser light. As illustrated in FIG. 1, the laser machining device 1 includes a liquid storage tank 2, a laser head 3, and a drive device 4.

The liquid storage tank 2 stores a light-blocking liquid L1 that has light blocking properties. The liquid storage tank 2 has a box-like shape that opens upward. As illustrated in FIG. 2, a placement table 11 and a sludge tray 12 are disposed inside the liquid storage tank 2. The workpiece W1 is disposed on the placement table 11. The placement table 11 includes, for example, a plurality of plate members coupled together in a grid shape. The sludge tray 12 is disposed below the placement table 11. The sludge tray 12 receives sludge produced when the workpiece W1 is machined with the laser light.

The drive device 4 moves the laser head 3 over the placement table 11. The drive device 4 moves the laser head 3 in the longitudinal direction (X), the transverse direction (Y), and the vertical direction (Z). The drive device 4 includes a first moveable stand 13, a second moveable stand 14, and a support stand 15. The first moveable stand 13 is supported so as to be moveable in the transverse direction (Y) with respect to the second moveable stand 14. The laser head 3 is supported so as to be moveable in the vertical direction (Z) with respect to the first moveable stand 13. The second moveable stand 14 is supported so as to be moveable in the longitudinal direction (X) with respect to the support stand 15. The first moveable stand 13 is moved in the transverse direction (Y) by a first motor 16 illustrated in FIG. 2. The laser head 3 is moved in the vertical direction (Z) by a second motor 17. The second moveable stand 14 is moved in the longitudinal direction (X) by a third motor 18.

As illustrated in FIG. 2, the laser machining device 1 includes a laser generator 19. The laser generator 19 generates laser light. The laser head 3 is connected to the laser generator 19. The laser generator 19 generates laser light by means of, for example, a fiber laser. The laser light has, for example a wavelength of 0.7 μm or greater and 10 μm or less. As illustrated in FIG. 2, the laser head 3 is connected to the laser generator 19 by means of a fiber cable 21. The laser head 3 includes a condensing lens 22. The laser head 3 causes the laser light from the laser generator 19 to be condensed on the workpiece W1 by means of the condensing lens 22.

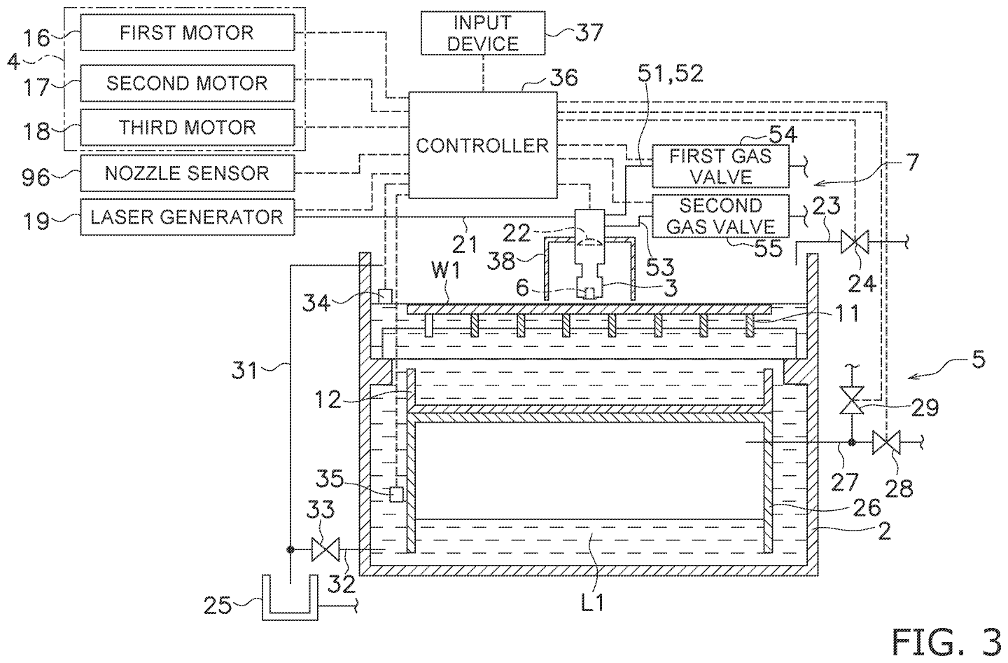

As illustrated in FIG. 2, the laser machining device 1 includes a liquid level adjustment device 5. The liquid level adjustment device 5 changes the height (referred to simply as “liquid level” below) of the liquid surface of the light-blocking liquid L1 inside the liquid storage tank 2. The liquid level adjustment device 5 is able to change the liquid level between a position lower than the workpiece W1 illustrated in FIG. 2 and a position higher than the workpiece W1 illustrated in FIG. 3.

The liquid level adjustment device 5 includes a supply pipe 23 and a supply valve 24. The supply pipe 23 is connected to an external tank 25 and the liquid storage tank 2. The external tank 25 is disposed outside of the liquid storage tank 2. The supply valve 2 is connected to the supply pipe 23. The light-blocking liquid L1 is supplied from the external tank 25 to the liquid storage tank 2 by opening the supply valve 24.

The liquid level adjustment device 5 includes an adjustment tank 26, a gas pipe 27, a pressurizing valve 28, and a pressure reducing valve 29. The inside of the adjustment tank 26 communicates with the inside of the liquid storage tank 2. The light-blocking liquid L1 is able to flow from the inside of the adjustment tank 26 to the inside of the liquid storage tank 2. The light-blocking liquid L1 is also able to flow from the inside of the liquid storage tank 2 to the inside of the adjustment tank 26. The gas pipe 27 connects the adjustment tank 26 and an unillustrated gas supply source. The pressurizing valve 28 and the pressure reducing valve 29 are connected to the gas pipe 27.

Gas is supplied to the inside of the adjustment tank 26 by opening the pressurizing valve 28. Consequently, as illustrated in FIG. 3, the light-blocking liquid L1 is pushed out from inside the adjustment tank 26 and flows into the liquid storage tank 2. Consequently, the liquid level in the liquid storage tank 2 rises. In addition, gas is exhausted from inside the adjustment tank 26 to the outside by opening the pressure reducing valve 29. Consequently, as illustrated in FIG. 2, the light-blocking liquid L1 flows from the liquid storage tank 2 into the adjustment tank 26. Consequently, the liquid level in the liquid storage tank 2 descends.

The liquid level adjustment device 5 includes an overflow pipe 31. The overflow pipe 31 is connected to the liquid storage tank 2 and the external tank 25. When the liquid level inside the liquid storage tank 2 is equal to or greater than a predetermined maximum height, the light-blocking liquid L1 inside the liquid storage tank 2 is discharged toward the external tank 25 via the overflow pipe 31.

The liquid level adjustment device 5 includes a discharge pipe 32 and a discharge valve 33. The discharge pipe 32 is connected to the liquid storage tank 2 and the external tank 25. The discharge valve 33 is connected to the discharge pipe 32. The light-blocking liquid L1 is discharged from the liquid storage tank 2 via the discharge pipe 32 to the external tank 25 by opening the discharge valve 33.

The light-blocking liquid L1 suppresses the permeation of the abovementioned laser light. The permeability of light in the wavelength region of 0.7 μm to 10 μm inclusive in the light-blocking liquid L1 is, for example, 10%/cm or less. Preferably, the permeability of light in the wavelength region of 0.7 μm to 10 μm inclusive in the light-blocking liquid L1 is 5%/cm or less. More preferably, the permeability of light in the wavelength region of 0.7 μm to 10 μm inclusive in the light-blocking liquid L1 is 3%/cm or less.

In the present embodiment, the light-blocking liquid L1 is a liquid in which an addition agent having light blocking properties is dispersed inside an aqueous solution. The addition agent includes, for example, carbon black. However, the addition agent may also be another substance having high light-blocking properties with respect to laser light. The concentration of the carbon black is, for example, 4.0-20.0% by mass. The concentration of the carbon black is preferably 5.0-10.0% by mass.

The laser machining device 1 includes a liquid level sensor 34 and a permeability sensor 35. The liquid level sensor 34 detects the liquid level of the light-blocking liquid L1 inside the liquid storage tank 2. The liquid level sensor 34 outputs a signal indicating the liquid level. The permeability sensor 35 detects the permeability with respect to laser light of the light-blocking liquid L1 inside the liquid storage tank 2. The permeability sensor 35 outputs a signal indicating the permeability.

The laser machining device 1 includes a controller 36 and an input device 37. The controller 36 includes a processor such as a CPU and a memory. The controller 36 stores programs and data for controlling the laser machining device 1. The drive device 4 and the laser generator 19 are controlled by signals from the controller 36. The supply valve 2, the pressurizing valve 28, and the pressure reducing valve 29 are controlled by signals from the controller 36. The controller 36 receives the signals from the liquid level sensor 34 and the permeability sensor 35.

The input device 37 is operable by the operator of the laser machining device 1. The input device 37 includes, for example, a switch. The input device 37 may also include a touch screen. The input device 37 may also include a connection port for an external recording medium. The input device 37 may also be an external computer. The operator uses the input device 37 to input machining conditions. The machining conditions include the thickness, the material, the machining speed, the design shape, etc., of the workpiece W1. The input device 37 outputs signals indicating the machining conditions to the controller 36.

The controller 36 controls the laser machining device 1 in accordance with the program and the machining condition, thereby cutting the workpiece W1 into a desired shape. The controller 36 controls the liquid level adjustment device 5 and changes the liquid level of the light-blocking liquid L1 inside the liquid storage tank 2. The controller 36 controls the laser generator 19 and irradiates the workpiece W1 with laser light from the laser head 3. The controller 36 controls the drive device 4 to move the laser head 3 above the workpiece W1.

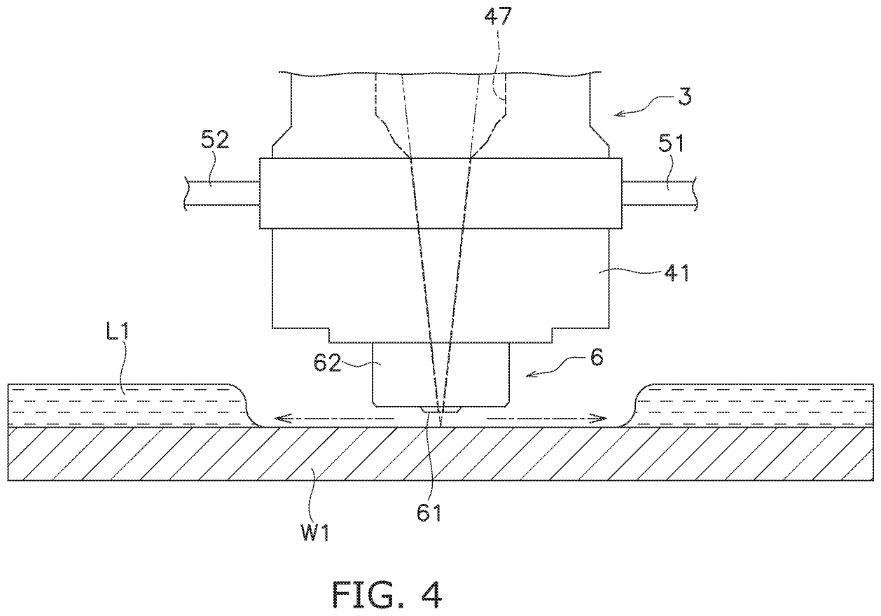

The laser machining device 1 according to the present embodiment, as illustrated in FIG. 3, performs machining of the workpiece W1 while the liquid level of the light-blocking liquid L1 is positioned above the workpiece W1. As illustrated in FIG. 4, a nozzle unit 6 is attached to the laser head 3. The laser head 3 irradiates the workpiece W1 with laser light from the nozzle unit 6.

In addition, the laser head 3 blows gas toward the workpiece W1 from the nozzle unit 6. Consequently, the light-blocking liquid L1 is removed from the surface of the workpiece W1 and the workpiece W1 is machined with the laser light. At this time, portions other than the machining range on the surface of the workpiece W1 are covered by the light-blocking liquid L1. As illustrated in FIG. 2, a light-blocking cover 38 is also attached to the laser head 3. Leakage of laser light upward from the machining range is prevented by the light-blocking cover 38. The machining range is a range on the surface of the workpiece W1 onto which the gas is blown. The machining range includes an irradiation point of the laser light on the surface of the workpiece W1. The machining range includes at least a range facing the nozzle unit 6.

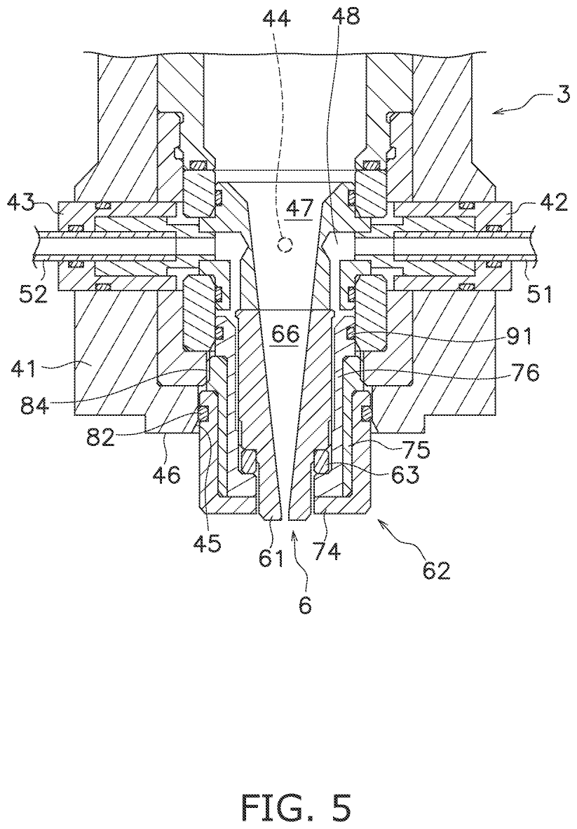

The structure of the laser head 3 and the nozzle unit 6 will be discussed in detail below. The nozzle unit 6 is attached to the tip end of the laser head 3. FIG. 5 is a cross-sectional view of the laser head 3 and the nozzle unit 6. As illustrated in FIG. 5, the laser head 3 includes a nozzle seat 41, a first gas port 42, a second gas port 43, and a third gas port 44.

The nozzle unit 6 is removably attached to the nozzle seat 41. The nozzle seat 41 includes a mounting hole 45. The mounting hole 45 extends upward from a tip end surface 46 of the nozzle seat 41. A portion of the nozzle unit 6 is disposed inside the mounting hole 45. The nozzle seat 41 includes a laser passage 47 and a gas passage 48. The laser passage 4 extends in the axial direction.

In the following explanation, the “axial direction” signifies the axial direction of the nozzle unit 6 and directions parallel to the axial direction of the nozzle unit 6. The “radial direction” signifies the radial direction of the nozzle unit 6 and directions parallel to the radial direction of the nozzle unit 6. Laser light passes through the laser passage 4 from the laser generator 19. The gas passage 48 is partitioned from the laser passage 4. The gas passage 48 is disposed outside of the laser passage 4 in the radial direction.

The first gas port 42, the second gas port 43, and the third gas port 44 are connected to the nozzle seat 41. The first gas port 42 and the second gas port 43 communicate with the gas passage 48 inside the nozzle seat 41. A first gas pipe 51 is connected to the first gas port 42. A second gas pipe 52 is connected to the second gas port 43. The third gas port 44 communicates with the laser passage 4 inside the nozzle seat 41. A third gas pipe 53 illustrated in FIG. 2 is connected to the third gas port 44.

As illustrated in FIG. 2, the laser machining device 1 includes a gas control device 7. The gas control device 7 controls the gas blown out of the laser head 3. The gas control device 7 includes a first gas valve 54 and a second gas valve 55. The first gas valve 54 and the second gas valve 55 are controlled by signals from the controller 36. The first gas pipe 51 and the second gas pipe 52 are connected to an unillustrated gas supply source via the first gas valve 54. A shielding gas is supplied to the laser head 3 through the first gas pipe 51 and the second gas pipe 52. The third gas pipe 53 is connected to an unillustrated gas supply source via the second gas valve 55. An assist gas is supplied to the laser head 3 through the third gas pipe 53.

When machining a mild steel or a low-carbon steel, oxygen is used, for example, as the assist gas for utilizing an oxidation-reduction reaction. When machining stainless steel, nitrogen is used, for example, as the assist gas for not utilizing the oxygen-reduction reaction and preventing the generation of oxides on the cutting surface. The shielding gas is used for removing the light-blocking liquid L1 from the surface of the workpiece W1 and, for example, inexpensive compressed air is used.

The nozzle unit 6 is removably attached to the laser head 3. That is, the nozzle unit 6 is attached in an exchangeable manner to the laser head 3. In the following explanation of the nozzle unit 6, the direction from the base end to the tip end of the nozzle unit 6 is defined as downward. Moreover, the direction from the tip end to the base end of the nozzle unit 6 is defined as upward.

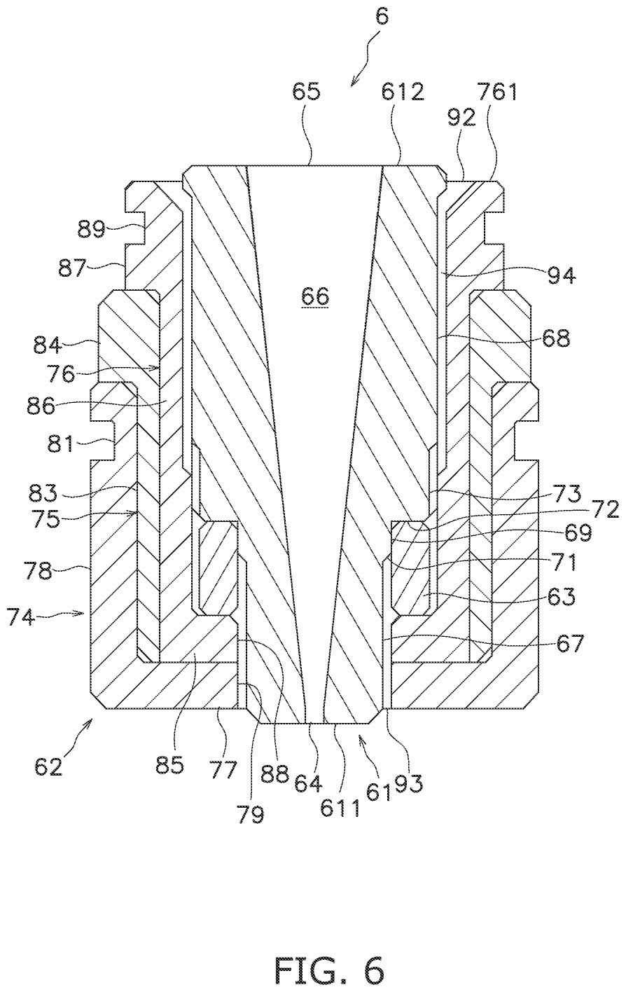

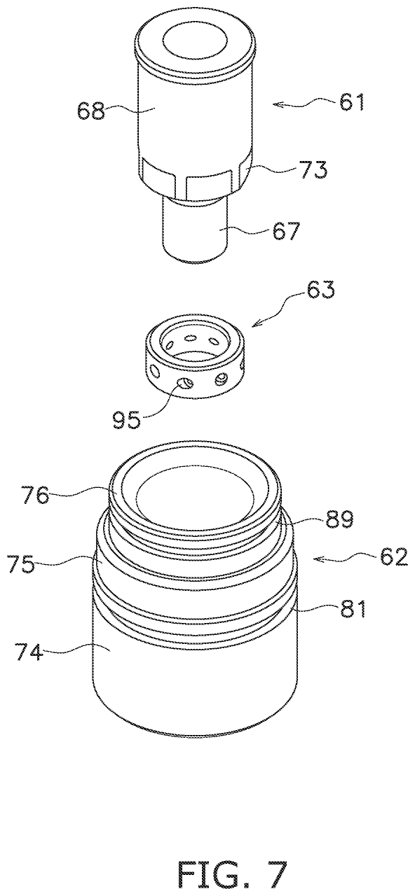

The tip end of the nozzle unit 6 signifies one of the end parts in the axial direction of the nozzle unit 6 facing the workpiece W1. The base end of the nozzle unit 6 is disposed on the opposite side of the tip end of the nozzle unit 6 in the axial direction of the nozzle unit 6. FIG. 6 is a cross-sectional view of the nozzle unit 6. FIG. 7 is an exploded perspective view of the nozzle unit 6. As illustrated in FIG. 6, the nozzle unit 6 includes an inner nozzle 61, an outer nozzle 62, and a swirler 63.

The inner nozzle 61 is made of a metal having conductivity. For example, the inner nozzle 61 is made of copper. However, the inner nozzle 61 may be made of a metal other than copper. The inner nozzle 61 includes a first opening 64, a second opening 65, and a through-hole 66. The first opening 64 is provided in the tip end 611 of the inner nozzle 61. The second opening 65 is provided in the base end 612 of the inner nozzle 61. The through-hole 66 communicates with the first opening 64 and the second opening 65. The through-hole 66 has a shape that is tapered toward the tip end 611 of the inner nozzle 61. That is, the inner diameter of the through-hole 66 becomes smaller toward the tip end 611 of the inner nozzle 61. The through-hole 66 is connected to the laser passage 47 inside the nozzle seat 41.

Laser light from the laser generator 19 enters into the through-hole 66 from the second opening 65. The laser light passes through the through-hole 66 and is irradiated from the first opening 64 toward the workpiece W1. In addition, the assist gas enters the through-hole 66 from the second opening 65. The assist gas passes through the through-hole 66 and is blown from the first opening 64 toward the workpiece W1.

The inner nozzle 61 includes a first nozzle section 67, a second nozzle section 68, and a swirler attachment section 69. The first nozzle section 67 extends upward from the tip end 611 of the inner nozzle 61. The second nozzle section 68 extends downward from the base end 612 of the inner nozzle 61. The second nozzle section 68 is longer than the first nozzle section 67 in the axial direction. The second nozzle section 68 is larger than the first nozzle section 67 in the radial direction.

The swirler attachment section 69 is disposed between the first nozzle section 67 and the second nozzle section 68. The swirler attachment section 69 is shorter than the first nozzle section 67 in the axial direction. The first nozzle section 67 is smaller than the swirler attachment section 69 in the radial direction. A first step section 71 is provided between the first nozzle section 67 and the swirler attachment section 69. The swirler attachment section 69 is smaller than the second nozzle section 68 in the radial direction. A second step section 72 is provided between the second nozzle section 68 and the swirler attachment section 69.

A plurality of recessed sections 73 are provided on the outer circumferential surface of the second nozzle section 68. The reference symbol of only one of the plurality of recessed sections 73 is given in the drawing, and the reference symbols of the other recessed sections 73 are omitted. The plurality of recessed sections 73 each have a shape that is recessed from the outer circumferential surface of the second nozzle section 68. The plurality of recessed sections 73 are disposed side by side in the circumferential direction on the outer circumferential surface of the second nozzle section 68. The plurality of recessed sections 73 are adjacent to the second step section 72.

The outer nozzle 62 is disposed on the outer circumference of the inner nozzle 61. The outer nozzle 62 covers a portion of the inner nozzle 61 from the outside in the radial direction. A portion of the outer nozzle 62 protrudes downward from the tip end surface 46 of the nozzle seat 41. A portion of the outer nozzle 62 is exposed to the outside of the laser head 3. Other portions of the outer nozzle 62 are disposed inside the mounting hole 45 of the nozzle seat 41.

The outer nozzle 62 includes an outer cap 74, a shield 75, and an insulation guide 76. The shield 75, the outer cap 74, and the insulation guide 76 are integrated. The shield 75, the outer cap 74, and the insulation guide 76 are joined together by, for example, press-fitting or bonding. Alternatively, the shield 75, the outer cap 74, and the insulation guide 76 may be joined by being screwed together.

The outer cap 74 is made of an insulator such as ceramic. However, the outer cap 74 may be made of another insulator such as a resin. The outer cap 74 is disposed on the outer circumference of the tip end 611 of the inner nozzle 61. A portion of the outer cap 74 is exposed to the outside of the laser head 3. Other portions of the outer cap 74 are disposed inside the mounting hole 45 of the nozzle seat 41.

The outer cap 74 includes a cap bottom surface 77 and a cap tube section 78. The cap bottom surface 77 includes a first hole 79. The first nozzle section 67 passes through the first hole 79. The cap bottom surface 77 is disposed on the outer circumference of the first nozzle section 67. The tip end 611 of the inner nozzle 61 protrudes from the cap bottom surface 77. However, the tip end 611 of the inner nozzle 61 may also be flush with the cap bottom surface 77. The cap bottom surface 77 is disposed facing the workpiece W1.

The cap tube section 78 extends upward from the cap bottom surface 77. The outer circumferential surface of the cap tube section 78 includes a first recessed groove 81. The first recessed groove 81 extends in the circumferential direction around the outer circumferential surface of the cap tube section 78. A first O-ring 82 illustrated in FIG. 5 is disposed in the first recessed groove 81. The space between the outer circumferential surface of the outer nozzle 62 and the inner circumferential surface of the mounting hole 45 is sealed by means of the first O-ring 82. Intrusion of the light-blocking liquid L1 into the inside of the laser head 3 is prevented by the first O-ring 82.

The shield 75 is disposed between the outer cap 74 and the inner nozzle 61. The shield 75 is disposed inwardly in the radial direction of the outer cap 74. The shield 75 is made of a metal having conductivity. For example, the shield 75 is made of brass. However, the shield 75 may be made of a metal other than brass.

The shield 75 includes a shield tube section 83 and a unit coupling section 84. The shield tube section 83 has a tubular shape that is open at the tip end. The shield tube section 83 is disposed inside the outer cap 74. The unit coupling section 84 protrudes upward from the outer cap 74. The unit coupling section 84 is disposed so as to be exposed outside of the nozzle unit 6. The unit coupling section 84 is wider in the radial direction than the shield tube section 83. The nozzle unit 6 is attached to the nozzle seat 41 at the unit coupling section 84. For example, male threads are provided to the unit coupling section 84 and female threads are provided to the inner circumferential surface of the mounting hole 45. The male threads of the unit coupling section 84 are screwed onto the female threads of the mounting hole 45. Consequently, the nozzle unit 6 is fixed to the nozzle seat 41.

The insulation guide 76 is disposed between the inner nozzle 61 and the shield 75. The insulation guide 76 is disposed outside of the inner nozzle 61 in the radial direction. The insulation guide 76 is disposed inside of the shield 75 in the radial direction. The shield 75 is covered by the outer cap 74 and the insulation guide 76. The insulation guide 76 is made of a material that has electrical insulation properties such as a resin. Alternatively, the insulation guide 76 may be made of another insulating material such as ceramic.

The insulation guide 76 includes a guide bottom surface 85, a guide tube section 86, and a guide seal section 87. The guide bottom surface 85 is provided to the tip end of the insulation guide 76. The guide bottom surface 85 faces the cap bottom surface 77 in the axial direction. The guide bottom surface 85 includes a second hole 88. The second hole 88 is aligned with the first hole 79 in the axial direction. The first nozzle section 67 passes through the second hole 88. The guide bottom surface 85 is disposed on the outer circumference of the first nozzle section 67.

The guide tube section 86 extends upward from the guide bottom surface 85. A portion of the first nozzle section 67, the swirler attachment section 69, and the second nozzle section 68 are disposed inside the guide tube section 86. The guide tube section 86 and the guide bottom surface 85 are disposed inside the shield 75. The guide seal section 87 protrudes upward from the shield 75. The guide seal section 87 is disposed so as to be exposed outside of the nozzle unit 6. The guide seal section 87 is wider in the radial direction than the guide tube section 86. The outer circumferential surface of the guide seal section 87 includes a second recessed groove 89. The second recessed groove 89 extends in the circumferential direction around the outer circumferential surface of the guide seal section 87. A second O-ring 91 illustrated in FIG. 5 is disposed in the second recessed groove 89. The space between the outer circumferential surface of the outer nozzle 62 and the inner circumferential surface of the mounting hole 45 are sealed by means of the second O-ring 91. Leakage of the shielding gas is prevented by the second O-ring 91.

The nozzle unit 6 includes a gas intake port 92, a gas outlet port 93, and a gas passage 94. The gas intake port 92 is provided in the base end of the nozzle unit 6. The gas intake port 92 is provided between the base end 612 of the inner nozzle 61 and the base end 761 of the insulation guide 76. The gas outlet port 93 is provided in the tip end of the nozzle unit 6. The gas outlet port 93 is provided between the tip end 611 of the inner nozzle 61 and the cap bottom surface 77 of the outer cap 74. The gas intake port 92, the gas outlet port 93, and the gas passage 94 have annular shapes.

The gas passage 94 is provided between the inner nozzle 61 and the outer nozzle 62. Specifically, the gas passage 94 is provided between the outer circumferential surface of the inner nozzle 61 and the inner circumferential surface of the insulation guide 76. The gas passage 94 communicates with the gas intake port 92 and the gas outlet port 93. The shielding gas enters the gas passage 94 from the gas intake port 92. The shielding gas passes through the gas passage 94 and is blown out of the gas outlet port 93.

The swirler 63 causes the shielding gas to swirl. The swirler 63 has an annular shape. The swirler 63 is an annular member having a swirling flow generation mechanism for causing the shielding gas to swirl. The swirler 63 is disposed inside the gas passage 94. The swirler 63 is disposed between the insulation guide 76 and the inner nozzle 61. The swirler 63 is disposed between the second step section 72 of the inner nozzle 61 and the guide bottom surface 85 of the insulation guide 76 in the axial direction. The swirler 63 is disposed on the outer circumference of the inner nozzle 61. The swirler 63 is attached to the swirler attachment section 69 of the inner nozzle 61.

For example, the swirler 63 is attached to the swirler attachment section 69 by press-fitting. Alternatively, the swirler 63 may be attached to the swirler attachment section 69 by another attachment means such as being screwed together. The first step section 71 of the inner nozzle 61 is disposed inside the swirler 63. The inner diameter of the swirler 63 is larger than the outer diameter of the first nozzle section 67. Therefore, a gap is provided between the outer circumferential surface of the first nozzle section 67 and the inner circumferential surface of the swirler 63. The gap is included in the gas passage 94.

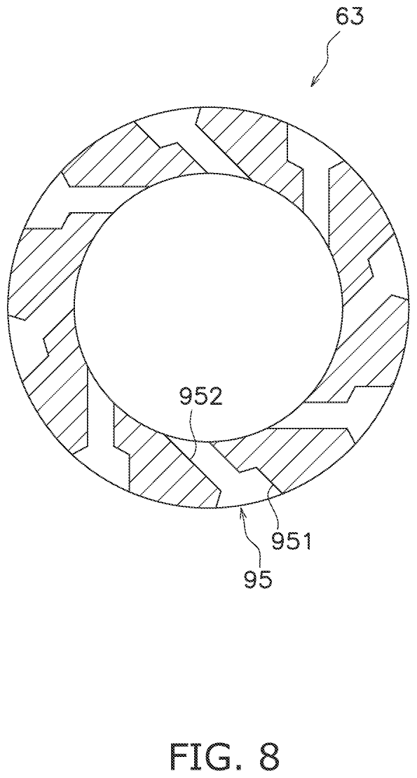

FIG. 8 is a cross-sectional view of the swirler 63. As illustrated in FIG. 8, the swirler 63 includes a plurality of holes 95. The reference symbol of only one of the plurality of holes 95 is given in the drawing, and the reference symbols of the other holes 95 are omitted. The plurality of holes 95 extend from the outer circumferential surface to the inner circumferential surface of the swirler 63. The holes 95 are slanted with respect to the radial direction when viewing the cross-section of the swirler 63 perpendicular to the axial direction. The holes 95 each include a first hole section 951 and a second hole section 952. The first hole section 951 communicates with the outer circumferential surface of the swirler 63. The second hole section 952 communicates with the inner circumferential surface of the swirler 63. The inner diameter of the second hole section 952 is smaller than the inner diameter of the first hole section 951.

The shielding gas enters the gas passage 94 from the gas intake port 92. The shielding gas becomes a swirling flow in the gas passage 94 by flowing from the outside of the swirler 63 through the plurality of holes 95 into the swirler 63. The shielding gas passes through the gas passage 94 and is jetted out of the gas outlet port 93 toward the workpiece W1.

As illustrated in FIG. 2, the laser machining device 1 includes a nozzle sensor 96. The nozzle sensor 96 detects the height of the inner nozzle 61 with respect to the workpiece W1. Specifically, the nozzle sensor 96 detects the capacitance between the inner nozzle 61 and the workpiece W1. The controller 36 calculates the height of the inner nozzle 61 with respect to the workpiece W1 with the capacitance. The controller 36 controls the drive device 4 and moves the laser head 3 in the height direction based on the height of the inner nozzle 61. Hereinbelow, the control of the laser machining device 1 by means of the controller 36 will be discussed.

First, as illustrated in FIG. 2, the workpiece W1 is mounted on the placement table 11 while the liquid level of the light-blocking liquid L1 is lower than the placement table 11. The controller 36 receives a starting instruction for machining from the input device 37 and then controls the liquid level adjustment device 5 to raise the liquid level of the light-blocking liquid L1. As illustrated in FIG. 3, the controller 36 raises the liquid level up to a predetermined position above the workpiece W1. Consequently, the workpiece W1 is submerged in the light-blocking liquid L1. For example, the liquid level during machining is a position a few millimeters to ten and a few millimeters above the workpiece W1. The controller 36 acquires the liquid level based on a signal from the liquid level sensor 34. The controller 36 detects the permeability of the light-blocking liquid L1 based on a signal from the permeability sensor 35.

Next, the controller 36 controls the drive device 4 to move the laser head 3 above the machining starting position of the workpiece W1. When the laser head 3 reaches the machining starting position, the controller 36 controls the gas control device 7 to cause the assist gas and the shielding gas to be blown out of the nozzle unit 6 while lowering the laser head 3 toward the workpiece W1. Consequently, the assist gas and the shielding gas are blown onto the surface of the workpiece W1 and, as illustrated in FIG. 4, the light-blocking liquid L1 is removed from the machining range on the surface of the workpiece W1.

The controller 36 acquires the height of the inner nozzle 61 from the workpiece W1 based on a signal from the nozzle sensor 96. The controller 36 lowers the inner nozzle 61 to a predetermined height position above the workpiece W1. The controller 36 starts machining the workpiece W1 with the laser light in accordance with the machining conditions. The controller 36 controls the laser generator 19, irradiates the workpiece W1 with laser light from the laser head 3, and cuts the workpiece W1. The controller 36 controls the drive device 4 to move the laser head 3 in the longitudinal direction (X) and the transverse direction (Y). Consequently, the workpiece W1 is cut in a shape in accordance with the machining conditions. When the permeability of the light-blocking liquid L1 is a predetermined threshold or greater, the controller 36 may not start the machining and may issue an alarm even if the starting instruction has been received.

When the machining of the workpiece W1 is complete, the controller 36 stops the irradiation of the laser light and the blowing of the gas. In addition, the controller 36 raises the laser head 3 and moves the laser head 3 to a predetermined standby position. The controller 36 lowers the liquid level of the light-blocking liquid L1 to a position lower than the workpiece W1. Consequently, the cut workpiece W1 can be transported from the placement table 11.

In the laser machining device 1 according to the present embodiment discussed above, machining is performed with laser light while blowing a gas onto the machining range of the workpiece W1. Therefore, portions other than the machining range are covered by the light-blocking liquid L1. As a result, the leakage of laser light is prevented with a simple structure.

In addition, a swirling flow of the shielding gas is generated by the swirler 63 in the nozzle unit 6 and the swirling flow is blown onto the surface of the workpiece W1. As a result, intrusion of the light-blocking liquid L1 into the machining range of the workpiece 1 is effectively suppressed. Consequently, the machining quality of the workpiece 1 is improved.

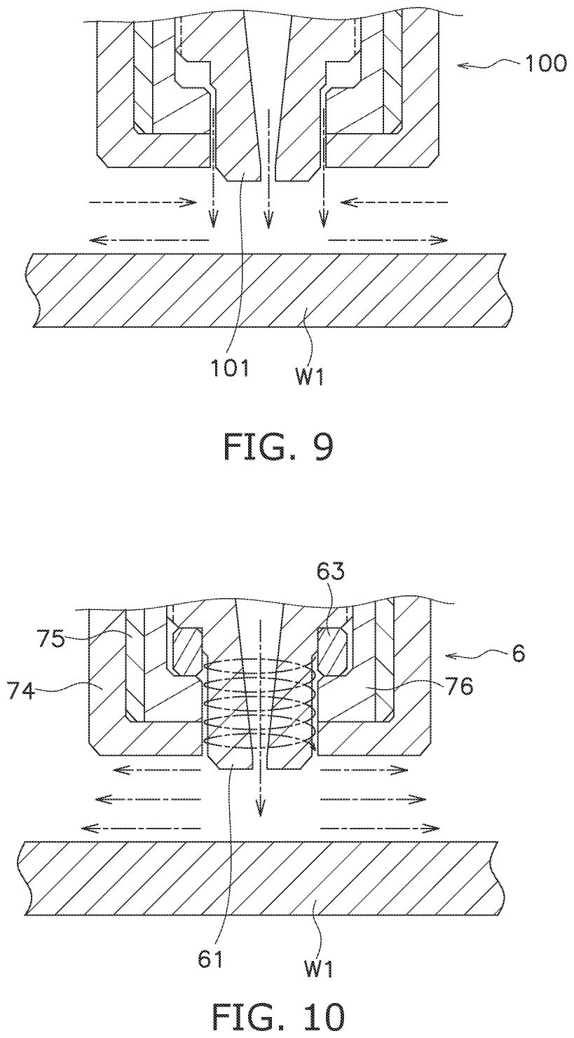

For example, FIG. 9 is a cross-sectional view of a nozzle unit 100 according to a comparative example and the workpiece W1. The chain line arrows in FIG. 9 indicate the flows of the assist gas and the shielding gas. The nozzle unit 100 according to the comparative example does not include the swirler 63 and the gas blown out of the nozzle unit 6 is an axial flow that flows parallel to the axial direction. The gas blown out of the nozzle unit 100 according to the comparative example collides with the surface of the workpiece W1 and changes direction to the radial direction. In this case, the gas flowing in the radial direction flows in a position near the surface of the workpiece W1. As a result, a flow of air is generated so as to be drawn toward the inner nozzle 101 as indicated by the dashed line arrows. Consequently, the light-blocking liquid L1 in the vicinity of the nozzle unit 6 can easily intrude into the machining range of the workpiece W1. When the light-blocking liquid L1 intrudes into the machining range of the workpiece W1, the machining quality of the workpiece W1 may be reduced. In addition, if the inner nozzle 101 becomes wet due the light-blocking liquid L1, the capacitance between the inner nozzle 101 and the workpiece W1 changes. As a result, it is possible that a false detection of the height of the inner nozzle 101 with respect to the workpiece W1 may occur.

In contrast, the nozzle unit 6 according to the present embodiment blows out a swirling flow of the shielding gas. FIG. 10 is a cross-sectional view of the nozzle unit 6 according to the present embodiment and the workpiece W1. As illustrated in FIG. 10, in the nozzle unit 6 according to the present embodiment, the swirling flow is dispersed in a tangential direction at the moment the air is blown out of the inner nozzle 61. As a result, the flow of air that is drawn in toward the inner nozzle 101 as in the nozzle unit 100 according to the comparative example is suppressed. Therefore, intrusion of the light-blocking liquid L1 into the machining range of the workpiece 1 is effectively suppressed. Consequently, the machining quality of the workpiece 1 is improved. In addition, the capacitance between the inner nozzle 61 and the workpiece W1 is detected accurately. Consequently, the height of the inner nozzle 61 with respect to the workpiece W1 can be detected accurately.

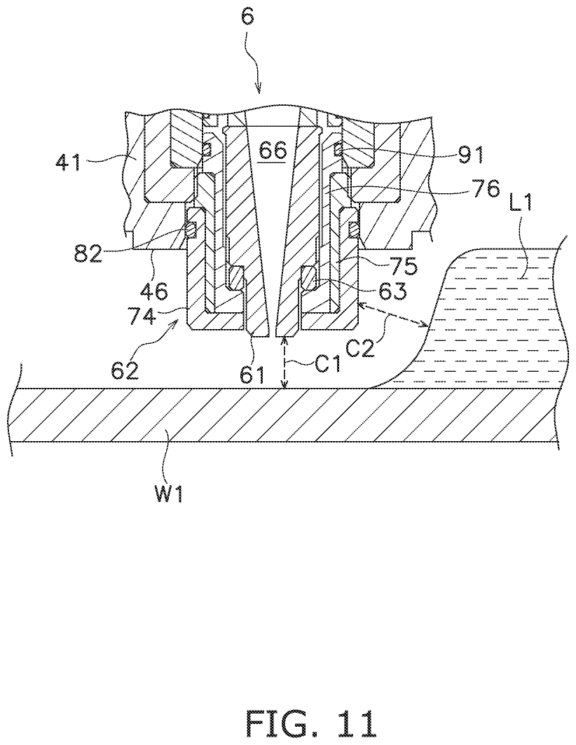

The outer nozzle 62 has a triple structure that includes the outer cap 74, the shield 75, and the insulation guide 76. Due to the shield 75, a false detection of a change of a capacitance C2 produced by a change in the position of the light-blocking liquid L1 as illustrated in FIG. 11, as a change in a capacitance C1 between the inner nozzle 61 and the workpiece W1 can be suppressed. In addition, the shield 75 is covered by the outer cap 74 and the insulation guide 76 that are insulated bodies. Consequently, the adhesion of droplets on the shield 75 is suppressed. As a result, false detection of the height of the inner nozzle 61 is suppressed.

In addition, resistance to spattering generated during cutting with the laser light is improved due to the outer cap 74 being made of ceramic. The insulation guide 76 is made of a resin whereby tight adhesion to the nozzle seat 41 is improved. Consequently, leakage of the shielding gas is suppressed.

Although an embodiment of the present invention has been described so far, the present invention is not limited to the above embodiment and various modifications may be made within the scope of the invention. The configuration of the laser machining device 1 is not limited to the above embodiment and may be modified. For example, the laser machining device 1 in the above embodiment cuts the workpiece W1 with the laser light. However, the laser machining device 1 may also weld the workpiece W1 with the laser light.

The laser generator 19 is not limited to a fiber laser and may also be a solid-state laser such as a YAG laser, or another type of laser such as a carbon dioxide laser. The configuration of the liquid level adjustment device 5 is not limited to the configuration of the above embodiment and may be modified. For example, the liquid level adjustment device 5 may also change the liquid level by controlling the supply amount of the light-blocking liquid L1 into the liquid storage tank 2.

The configuration of the nozzle unit 6 is not limited to the above embodiment and may be modified. For example, the swirler 63 may also be provided so as to cause the assist gas to swirl. The swirler 63 may be formed integrally with the inner nozzle 61. The shape of the inner nozzle 61 is not limited to the above embodiment and may be modified. The configuration of the outer nozzle 62 is not limited to the configuration of the above embodiment and may be modified. The shape of the outer cap 74 is not limited to the above embodiment and may be modified. The shape of the shield 75 is not limited to the configuration of the above embodiment and may be modified. The shape of the insulation guide 76 is not limited to the above embodiment and may be modified.

According to the present invention, intrusion of the light-blocking liquid into the machining range of the workpiece is effectively suppressed in the laser machining device. Consequently, the machining quality of the workpiece is improved.

1. A nozzle unit for a laser machining device that uses laser light to machine a workpiece disposed in a light-blocking liquid having light-blocking properties, the nozzle unit comprising:
an inner nozzle through which the laser light passes;
a gas outlet port that blows a gas toward the workpiece in order to remove the light-blocking liquid from between the inner nozzle and the workpiece; and
a swirler that causes the gas to swirl.

2. The nozzle unit according to claim 1, further comprising:
an outer nozzle disposed on an outer circumference of the inner nozzle, and
a gas passage provided between the inner nozzle and the outer nozzle, the gas passage communicating with the gas outlet port.

3. The nozzle unit according to claim 2, wherein
the swirler is disposed in the gas passage.

4. The nozzle unit according to claim 2, wherein
the swirler has an annular shape and is disposed on the outer circumference of the inner nozzle, and
the swirler includes a plurality of holes that are slanted in a radial direction of the swirler as seen in a cross-section perpendicular to an axial direction of the swirler.

5. The nozzle unit according to claim 2, wherein
the outer nozzle includes an outer cap made of an insulator and disposed on the outer circumference of a tip end of the inner nozzle.

6. The nozzle unit according to claim 5, wherein
the outer nozzle further includes a metal shield disposed between the outer cap and the inner nozzle.

7. The nozzle unit according to claim 6, wherein
the outer nozzle further includes an insulation guide disposed between the inner nozzle and the shield.

8. The nozzle unit according to claim 7, wherein
the shield is covered by the outer cap and the insulation guide.

9. The nozzle unit according to claim 7, wherein
the gas passage is provided between the insulation guide and the inner nozzle, and
the swirler is disposed between the insulation guide and the inner nozzle.

10. The nozzle unit according to claim 6, wherein
the shield includes a unit coupling section that is disposed so as to be exposed outside of the nozzle unit, and
the nozzle unit is attached to the laser machining device with the unit coupling section.

11. A laser machining device including the nozzle unit according to claim 1, the laser machining device further comprising:
a liquid storage tank configured to store the light-blocking liquid;
a placement stand disposed inside the liquid storage tank and on which the workpiece is placed;
a laser generator configured to generate the laser light;
a laser head connected to the laser generator and disposed above the placement stand; and
a drive device configured to move the laser head, the nozzle unit being attached to the laser head.

12. The laser machining device according to claim 11, further comprising:
a sensor configured to detect a capacitance between the inner nozzle and the workpiece; and
a controller configured to
calculate a height of the inner nozzle with respect to the workpiece with the capacitance, and
control the drive device to move the laser head in a height direction.
